(19) United States
(12) Patent Application Publication
(10) Pub. No.: US 2025/0267225 A1
(43) Pub. Date: Aug. 21, 2025

(54) Methods and Systems for Communicating Data on an Electronic Device

(71) Applicant: Lexmark International, Inc., Lexington, KY (US)

(72) Inventors: Samuel Robert Davidson, Lexington, KY (US); Timothy John Rademacher, Richmond, KY (US); Jennifer Topmiller Williams, Lexington, KY (US)

(21) Appl. No.: 18/581,082

(22) Filed: Feb. 19, 2024

(51) Int. Cl. H04N 1/00; H04N 1/44

(52) U.S. Cl. CPC H04N 1/0083; H04N 1/44

(57) ABSTRACT

A method of receiving data from a first component of an imaging device, by a second component of the imaging device, comprising: determining, by the second component, indirect data from a feature of a communication between the first and second components of the imaging device, wherein the communication is a data line communication. A supply item for an imaging device configured to receive data from a first component of the imaging device by determining indirect data from a feature of a communication between the first component of the imaging device and the supply item, wherein the communication is a data line. Alternatively, the supply item is configured to send data to the first component of the imaging device by converting indirect data into a feature of a communication and causing the communication to occur between the first component and the supply item, wherein the communication is a data line.

### CROSS REFERENCE TO RELATED APPLICATIONS

None.

### BACKGROUND

### 1. Technical Field

The present disclosure generally relates to methods, devices and systems for communicating data on an electronic device, and, more particularly, methods, devices and systems for communicating data on an imaging device.

### 2. Description of the Related Art

In electronic systems, it is often desirable to confirm the authenticity of a component of the electronic system to ensure that the entire system operates as designed. Non-authentic components employ various techniques to mimic the behavior of authentic components. This may include copying the authentic component's circuits and memory contents in order to duplicate authentication algorithms or encrypted communication between the component and the rest of the electronic system. This is particularly important in printing systems where it is desirable to confirm the authenticity of a supply component of the printing system to ensure correct operation.

It is often desirable to change the behavior of an electronic system during its lifecycle, by making changes to functionality including utilizing one of several installed authentication algorithms and selecting keys to be used in the authentication algorithms. Changes of functionality can be communicated in commands send from one component to another which dictate, for example, the algorithm to be used. To protect the data sent, such commands are often encrypted. However, if a third party successfully decrypts the data, the parameters may be discovered to be utilized by non-authentic components which more successfully mimic authentic components.

In order to ensure the use of authentic components in an electronic device, it is desirable to more robustly protect data communicated between components. Accordingly, there is a need for improved systems and methods for communicating data in electronic devices.

### SUMMARY

The present disclosure provides example methods and systems that may be implemented in any general electronic system or specifically in an imaging/printing device/system to thwart the use of non-authentic components.

There is provided a method of receiving data from a first component of an imaging system, by a second component of the imaging system, the method comprising: determining, by the second component, indirect data from a feature of a communication between the first and second components of the imaging system.

In certain implementations, the communication is a data line communication. In other words, the feature which the indirect data is determined from is a feature of a data line transmission. In certain implementations, communication between the first and second component utilises a data line and a clock line. In certain implementations which do not utilise a clock line, the main/only communication channel/line is considered to be the data line for the purpose of this specification.

In certain implementations, determining indirect data from the feature of the communication comprises measuring a property of the feature. The indirect data may be considered as out-of-band data.

In certain implementations, measuring the property of the feature comprises counting. In certain implementations, the property is a number of bytes in the feature. In certain implementations, the property is a number of transmissions. In certain implementations, the number of transmissions is a number of a type of transmission. In certain implementations, the type of transmission is a busy response. In certain implementations, the number of transmissions is a number of consecutive transmissions of the same type. For example, the number of transmissions may be a number of read transmissions, a number of write transmissions, or a number of identical transmissions. In certain implementations, the number of transmissions is a number of transmissions while a condition is met. In certain implementations, the condition is that an operation is running, or that one of the components, such as the receiving component is busy.

In certain implementations, measuring the property of the feature comprises timing. In certain implementations, the property is a time period between receiving two transmissions and timing comprises measuring the length of the time period. In certain implementations, the two transmissions comprise a start transmission indicating a start of the timing and an end transmission indicating the end of timing. In certain implementations, the property is a time period over which a type of transmission is received and timing comprises measuring the length of the time period.

In certain implementations, converting a measured time into a time count by dividing the measured time by an interval time. The interval time may be larger than the tolerances of the first and/or second component. In this way, the first and second component can reach the same time count despite small errors in their timing mechanisms. The time interval may be 5 ms.

In certain implementations, measuring the property of the feature comprises measuring a voltage of the communication. For example, measuring a voltage of the communication may comprises measuring a change in voltage between a highest and lowest voltage in the communication, or measuring a highest or lowest voltage of the communication.

In certain implementations, the communication may comprise further indirect data which may be encoded in and determined from further features of the communication. The further features may be of the same type as the first feature or a different type. For example, indirect data may be determined by counting a number of bytes of a first feature and further indirect data may be determined by timing a further feature of the communication.

In certain implementations, the indirect data indicates functionality to be performed by the supply item and/or component. In certain implementations, the functionality to be performed by the second component is an algorithm. In certain implementations, the algorithm is an authentication algorithm.

In certain implementations, receiving data further comprises using the indirect data to determine functionality to be performed by the second component. In certain implementations, the method further comprises determining a property of the algorithm via a look-up table. The look-up table may be stored by the first component and the second component. The property of the algorithm may be a type of algorithm to be performed, a number of times to perform an operation, and/or a key to use in the algorithm, and/or a frequency at which an operation is run, and/or how long an operation is run. In certain implementations, the method further comprises determining a property of the algorithm using the indirect data by modifying an existing stored parameter, for example, shifting a stored key.

In this specification, look-up tables may be stored on each of the components written on non-volatile memory.

In certain implementations, using the indirect data to determine functionality to be performed by the second component comprises using the indirect data as an index into direct data sent in the communication. For example, the indirect data may indicate a count of the number of bytes of direct data to read, a start byte for reading the direct data, or a frequency of bytes to read or discard. For example, when the indirect data indicates a start byte, indirect data with a value of 3 may cause the second component to ignore the first three bytes of direct data and begin reading the direct data at the fourth byte. Alternatively, when the indirect data indicates a read frequency, indirect data with a value of 3 may cause the second component to ignore every third byte of direct data (therefore reading byte 0, 1, 3, 4, 6, 7 etc.).

In certain implementations, using the indirect data to determine functionality to be performed by the second component comprises using the indirect data as an input to an operation performed on data, optionally direct data sent in the communication. The operation may transform the direct data into new data to be read.

There is further provided a method of determining authenticity of a first component installed in an imaging device, the method comprising: receiving data from the first component, by a second component installed in the imaging device according to the method of receiving data described above, and determining whether the first component is authentic based on the received data. For example, if valid indirect data is received, it can be determined that the first component correctly converted the indirect data into the feature of the communication. When valid indirect data is received at the second component, it can be determined that the first component is authentic. In certain implementations, determining whether the first component is authentic comprises using the indirect data to perform an authentication algorithm.

There is further provided, a method of sending data by a first component installed in an imaging device, to a second component installed in the imaging device, the method comprising: converting, by the first component, indirect data into a feature of a communication and causing the communication to occur between the first and second components. In certain implementations, the communication is a data line communication. In certain implementations, for example, when the first component is configured as a follower component, causing the communication to occur may comprise making a message available to be read by a leader component.

In certain implementations, converting indirect data into the feature of the communication comprises establishing a property of the feature, based on the indirect data. In certain implementations, establishing the property comprises setting a countable number of components of the feature. In certain implementations, the property is a number of bytes in the feature. In certain implementations, the feature comprises: a first portion having the number of bytes, a check value of the first portion and a second portion. In this way, features containing different indirect data have the same overall length, thereby reducing the risk that the indirect data can be determined by an non-authentic component. Authentic components receiving such a feature determine the number of bytes in the feature up to the check value by calculating a check value of an increasing number of bytes until the calculated check value matches the next value in the feature. The indirect data is then determined as the number of bytes in the portion producing the calculated check value matching the received check value.

In certain implementations, the property is a number of transmissions in the feature. In certain implementations, the property is a time period of the feature. In certain implementations, the feature comprises sending a first transmission, waiting for the time period and then sending a second transmission. In certain implementations, the feature comprises sending a transmission, or a type of transmission, regularly for the time period.

In certain implementations, establishing the property of the feature comprises setting a voltage of the communication. For example, the voltage of the communication may be a change in voltage between a highest and lowest voltage in the communication, or a highest or lowest voltage of the communication.

In certain implementations, the indirect data indicates functionality to be performed by the supply item and/or component. In certain implementation, the indirect data in combination with previously communicated data (such as previous indirect data sent in previous communications) may indicate the functionality to be performed. For example, the indirect data when added to a cumulative total may indicate the functionality to be performed. In certain implementations, sending data further comprises setting the indirect data to indicate functionality to be performed by the second component. In certain implementations, the functionality to be performed is an algorithm. In certain implementations, the algorithm is an authentication algorithm.

In certain implementations, a look-up table is used to set the indirect data to indicate a property of the algorithm. The look-up table may be stored by the first component and the second component. The property of the algorithm may be a type of algorithm to be performed, a number of times to perform a computation, and/or a key to use in the algorithm. The first component may select the property from the look-up table at random, or using a predetermined sequence.

In certain implementations, the indirect data is an index into direct data sent in the communication. For example, the indirect data may indicate a count of the number of bytes of direct data to be read, a start byte for reading the direct data, or a frequency of bytes to read or discard. In certain implementations, the indirect data is an input to a computation to be performed by the supply item and/or component, for example, on direct data sent in the communication. For example, each nibble (half byte) of a current dataset can be XOR'ed with the indirect data to calculate a new dataset. The nibble position can rotate the count to make the data appear more random. For example, assume the current dataset is 0xB592 and the count is 6. The hexadecimal value 2, which is binary 0010, is in nibble position 0 so the rotated count is binary 0110 (6<<<0). XORing the value with the rotated count results in binary 0100, which is hexadecimal 4. The hexadecimal value 9, which is binary 1001, is in nibble position 1 so the rotated count is binary 1100 (6<<<1). XORing the value with the rotated count results in binary 0101, which is hexadecimal 5. The hexadecimal value 5, which is binary 0101, is in nibble position 2 so the rotated count is binary 1001 (6<<<2). XORing the value with the rotated count results in binary 1100, which is hexadecimal C. The hexadecimal value B, which is binary 1011, is in nibble position 3 so the rotated count is binary 0011 (6<<<3). XORing the value with the rotated count results in binary 1000, which is hexadecimal 8. Therefore, the new data is 0x8C54.

In certain implementations, the indirect data indicates a modification to be made to an existing stored parameter, for example, a shift of a stored key.

In certain implementations, the communication may comprise further indirect data which may be encoded in and determined from further features of the communication. The further features may be of the same type as the first feature or a different type. For example, indirect data may be established as a number of bytes of a first feature and further indirect data may be established as a time of a further feature of the communication.

In certain implementations, the first component may select the functionality to be indicated by the indirect data at random or using a predetermined sequence and set the indirect data to the value corresponding to the selected functionality. The functionality may be varied with each communication.

In certain implementation, the method further comprises using the functionality indicated by the indirect data for one instance, or using the functionality indicated by the indirect data until further indirect data is communicated.

There is further provided a method of communicating data between a first and a second component of an imaging device comprising: sending the data by the first component of the imaging device, to the second component of the imaging device by the method of sending data described above, and receiving the data from the first component of the imaging device, by the second component of the imaging device according to the method of receiving data described above.

In certain implementations, the first component is a supply item installed in the imaging device. The supply item may be configured to behave as either the first or the second component, depending on the circumstances. For example, the supply item may be able to send indirect data to a component of the imaging device, and also to receive indirect data from a component of the imaging device.

In certain implementations, determining whether the first component is authentic comprises using the indirect data to perform an authentication algorithm.

There is further provided a method of determining authenticity of a second component installed in an imaging device, the method comprising: sending data from a first component of an imaging device to the second component of the imaging device according to the method of sending data described above, receiving a response from the second component at the first component, and determining whether the second component is authentic based on the response. The indirect data sent to the second component indicates functionality to be performed by the second component in order to generate the response. So, determining whether the response is correctly generated based on the indirect data determines whether the second component has the capability of determining the indirect data. When the response matches an expected response based on the indirect data, the second component is determined to be authentic. When the response does not match the expected response based on the indirect data, the second component is determined to be non-authentic.

In certain implementations, determining whether the second component is authentic comprises using the response and the indirect data to perform an authentication algorithm. For example, an operation may be performed using the indirect data and the result compared with the response to determine if the operation was successfully performed by the second component to generate the response. In this way, it can be determined if the second component correctly determined the indirect data from the communication sent to the second component by the first component.

There is further provided a supply item for an imaging device, the supply item configured to, when installed in the imaging device: receive data from a first component of the imaging device by: determining indirect data from a feature of a communication between the first component of the imaging device and the supply item, and/or send data to the first component of the imaging device by: converting indirect data into a feature of a communication and causing the communication to occur between the first component and the supply item. The supply item may be configured to perform one or more of the methods described above. In certain implementations, the communication is a data line communication.

In certain implementations, the supply item is further configured to perform an authentication algorithm based on the indirect data.

There is further provided an imaging device, the imaging device comprising a component configured to: receive data from a supply item installed in the imaging device by: determining indirect data from a feature of a communication between the component of the imaging device and the supply item, and/or send data to the supply item installed in the imaging device by: converting indirect data into a feature of a communication and causing the communication to occur between the component and the supply item. In certain implementations, the communication is a data line communication.

In certain implementations, the indirect data indicates functionality to be performed by the supply item and/or component. In certain implementations, the functionality to be performed is an algorithm and the imaging device stores a look-up table for setting a property of the algorithm based on the indirect data. In certain implementations, the indirect data is an index into direct data sent in the communication. In certain implementations, the indirect data is an input to a computation to be performed by the supply item and/or component on direct data sent in the communication.

In certain implementations, the indirect data is encoded in a property of the feature. In certain implementations, the property is a number of bytes in the feature. In certain implementations, the property is a number of transmissions in the feature. In certain implementations, the imaging device is further configured to determine whether the supply item installed in the imaging device is authentic, based on (i) indirect data received from the supply item, and/or (ii) a response received from the supply item to indirect data sent to the supply item. In certain implementations, determining whether the supply item is authentic comprises using the response and/or the indirect data to perform an authentication algorithm.

There is further provided an imaging system comprising the imaging device as described above and a supply item installed in the imaging device, the supply item configured to, when installed in the imaging device: receive data from a first component of the imaging device by: determining indirect data from a feature of a communication between the first component of the imaging device and the supply item, and/or send data to the first component of the imaging device by: converting indirect data into a feature of a communication and causing the communication to occur between the first component and the supply item. In certain implementations, the communication is a data line communication.

There is further provided an imaging system comprising an imaging device as described above and a supply item as described above.

In certain implementations of the above methods, imaging devices, supply items and imaging systems, when it is determined that a component or supply item is non-authentic, normal operation of the imaging device is prevented. In certain implementations, preventing normal operation of the imaging device comprises interrupting signals sent to a print component. A print component may be a print head, a monitor-enforce block or another component utilised in printing by the imaging device. Preventing the normal operation of the imaging device may be performed by host firmware or by the component, or by a third component such as a security device.

There is provided a method of receiving data from a first component of an electronic system, by a second component of the electronic system, the method comprising: determining, by the second component, indirect data from a feature of a communication between the first and second components of the electronic system.

In certain implementations, the communication is a data line communication. In other words, the feature which the indirect data is determined from is a feature of a data line transmission. In certain implementations, communication between the first and second component utilises a data line and a clock line. In certain implementations which do not utilise a clock line, the main/only communication channel/line is considered to be the data line for the purpose of this specification.

In certain implementations, determining indirect data from the feature of the communication comprises measuring a property of the feature. The indirect data may be considered as out-of-band data.

In certain implementations, measuring the property of the feature comprises counting. In certain implementations, the property is a number of bytes in the feature. In certain implementations, the property is a number of transmissions. In certain implementations, the number of transmissions is a number of a type of transmission. In certain implementations, the type of transmission is a busy response. In certain implementations, the number of transmissions is a number of consecutive transmissions of the same type. For example, the number of transmissions may be a number of read transmissions, a number of write transmissions, or a number of identical transmissions. In certain implementations, the number of transmissions is a number of transmissions while a condition is met. In certain implementations, the condition is that an operation is running, or that one of the components, such as the receiving component is busy.

In certain implementations, measuring the property of the feature comprises timing. In certain implementations, the property is a time period between receiving two transmissions and timing comprises measuring the length of the time period. In certain implementations, the two transmissions comprise a start transmission indicating a start of the timing and an end transmission indicating the end of timing. In certain implementations, the property is a time period over which a type of transmission is received and timing comprises measuring the length of the time period.

In certain implementations, converting a measured time into a time count by dividing the measured time by an interval time. The interval time may be larger than the tolerances of the first and/or second component. In this way, the first and second component can reach the same time count despite small errors in their timing mechanisms. The time interval may be 5 ms.

In certain implementations, measuring the property of the feature comprises measuring a voltage of the communication. For example, measuring a voltage of the communication may comprises measuring a change in voltage between a highest and lowest voltage in the communication, or measuring a highest or lowest voltage of the communication.

In certain implementations, the communication may comprise further indirect data which may be encoded in and determined from further features of the communication. The further features may be of the same type as the first feature or a different type. For example, indirect data may be determined by counting a number of bytes of a first feature and further indirect data may be determined by timing a further feature of the communication.

In certain implementations, the indirect data indicates functionality to be performed by the replaceable component and/or component. In certain implementations, the functionality to be performed by the second component is an algorithm. In certain implementations, the algorithm is an authentication algorithm.

In certain implementations, receiving data further comprises using the indirect data to determine functionality to be performed by the second component. In certain implementations, the method further comprises determining a property of the algorithm via a look-up table. The look-up table may be stored by the first component and the second component. The property of the algorithm may be a type of algorithm to be performed, a number of times to perform an operation, and/or a key to use in the algorithm, and/or a frequency at which an operation is run, and/or how long an operation is run. In certain implementations, the method further comprises determining a property of the algorithm using the indirect data by modifying an existing stored parameter, for example, shifting a stored key.

In this specifications, look-up tables may be stored on each of the components written on non-volatile memory.

In certain implementations, using the indirect data to determine functionality to be performed by the second component comprises using the indirect data as an index into direct data sent in the communication. For example, the indirect data may indicate a count of the number of bytes of direct data to read, a start byte for reading the direct data, or a frequency of bytes to read or discard. For example, when the indirect data indicates a start byte, indirect data with a value of 3 may cause the second component to ignore the first three bytes of direct data and begin reading the direct data at the fourth byte. Alternatively, when the indirect data indicates a read frequency, indirect data with a value of 3 may cause the second component to ignore every third byte of direct data (therefore reading byte 0, 1, 3, 4, 6, 7 etc.).

In certain implementations, using the indirect data to determine functionality to be performed by the second component comprises using the indirect data as an input to an operation performed on data, optionally direct data sent in the communication. The operation may transform the direct data into new data to be read.

There is further provided a method of determining authenticity of a first component installed in an electronic device, the method comprising: receiving data from the first component, by a second component installed in the electronic device according to the method of receiving data described above, and determining whether the first component is authentic based on the received data. For example, if valid indirect data is received, it can be determined that the first component correctly converted the indirect data into the feature of the communication. When valid indirect data is received at the second component, it can be determined that the first component is authentic. In certain implementations, determining whether the first component is authentic comprises using the indirect data to perform an authentication algorithm.

There is further provided, a method of sending data by a first component installed in an electronic device, to a second component installed in the electronic device, the method comprising: converting, by the first component, indirect data into a feature of a communication and causing the communication to occur between the first and second components. In certain implementations, the communication is a data line communication. In certain implementations, for example, when the first component is configured as a follower component, causing the communication to occur may comprise making a message available to be read by a leader component.

In certain implementations, converting indirect data into the feature of the communication comprises establishing a property of the feature, based on the indirect data. In certain implementations, establishing the property comprises setting a countable number of components of the feature. In certain implementations, the property is a number of bytes in the feature. In certain implementations, the feature comprises: a first portion having the number of bytes, a check value of the first portion and a second portion. In this way, features containing different indirect data have the same overall length, thereby reducing the risk that the indirect data can be determined by an non-authentic component. Authentic components receiving such a feature determine the number of bytes in the feature up to the check value by calculating a check value of an increasing number of bytes until the calculated check value matches the next value in the feature. The indirect data is then determined as the number of bytes in the portion producing the calculated check value matching the received check value.

In certain implementations, the property is a number of transmissions in the feature. In certain implementations, the property is a time period of the feature. In certain implementations, the feature comprises sending a first transmission, waiting for the time period and then sending a second transmission. In certain implementations, the feature comprises sending a transmission, or a type of transmission, regularly for the time period.

In certain implementations, establishing the property of the feature comprises setting a voltage of the communication. For example, the voltage of the communication may be a change in voltage between a highest and lowest voltage in the communication, or a highest or lowest voltage of the communication.

In certain implementations, the indirect data indicates functionality to be performed by the replaceable component and/or component. In certain implementation, the indirect data in combination with previously communicated data (such as previous indirect data sent in previous communications) may indicate the functionality to be performed. For example, the indirect data when added to a cumulative total may indicate the functionality to be performed. In certain implementations, sending data further comprises setting the indirect data to indicate functionality to be performed by the second component. In certain implementations, the functionality to be performed is an algorithm. In certain implementations, the algorithm is an authentication algorithm.

In certain implementations, a look-up table is used to set the indirect data to indicate a property of the algorithm. The look-up table may be stored by the first component and the second component. The property of the algorithm may be a type of algorithm to be performed, a number of times to perform a computation, and/or a key to use in the algorithm. The first component may select the property from the look-up table at random, or using a predetermined sequence.

In certain implementations, the indirect data is an index into direct data sent in the communication. For example, the indirect data may indicate a count of the number of bytes of direct data to be read, a start byte for reading the direct data, or a frequency of bytes to read or discard. In certain implementations, the indirect data is an input to a computation to be performed by the replaceable component and/or component, for example, on direct data sent in the communication. For example, each nibble (half byte) of a current dataset can be XOR'ed with the indirect data to calculate a new dataset. The nibble position can rotate the count to make the data appear more random. For example, assume the current dataset is 0xB592 and the count is 6. The hexadecimal value 2, which is binary 0010, is in nibble position 0 so the rotated count is binary 0110 (6<<<0). XORing the value with the rotated count results in binary 0100, which is hexadecimal 4. The hexadecimal value 9, which is binary 1001, is in nibble position 1 so the rotated count is binary 1100 (6<<<1). XORing the value with the rotated count results in binary 0101, which is hexadecimal 5. The hexadecimal value 5, which is binary 0101, is in nibble position 2 so the rotated count is binary 1001 (6<<<2). XORing the value with the rotated count results in binary 1100, which is hexadecimal C. The hexadecimal value B, which is binary 1011, is in nibble position 3 so the rotated count is binary 0011 (6<<<3). XORing the value with the rotated count results in binary 1000, which is hexadecimal 8. Therefore, the new data is 0x8C54.

In certain implementations, the indirect data indicates a modification to be made to an existing stored parameter, for example, a shift of a stored key.

In certain implementations, the communication may comprise further indirect data which may be encoded in and determined from further features of the communication. The further features may be of the same type as the first feature or a different type. For example, indirect data may be established as a number of bytes of a first feature and further indirect data may be established as a time of a further feature of the communication.

In certain implementations, the first component may select the functionality to be indicated by the indirect data at random or using a predetermined sequence and set the indirect data to the value corresponding to the selected functionality. The functionality may be varied with each communication.

In certain implementation, the method further comprises using the functionality indicated by the indirect data for one instance, or using the functionality indicated by the indirect data until further indirect data is communicated.

There is further provided a method of communicating data between a first and a second component of an electronic device comprising: sending the data by the first component of the electronic device, to the second component of the electronic device by the method of sending data described above, and receiving the data from the first component of the electronic device, by the second component of the electronic device according to the method of receiving data described above.

In certain implementations, the first component is a replaceable component installed in the electronic device. The replaceable component may be configured to behave as either the first or the second component, depending on the circumstances. For example, the replaceable component may be able to send indirect data to a component of the electronic device, and also to receive indirect data from a component of the electronic device.

In certain implementations, determining whether the first component is authentic comprises using the indirect data to perform an authentication algorithm.

There is further provided a method of determining authenticity of a second component installed in an electronic device, the method comprising: sending data from a first component of an electronic device to the second component of the electronic device according to the method of sending data described above, receiving a response from the second component at the first component, and determining whether the second component is authentic based on the response. The indirect data sent to the second component indicates functionality to be performed by the second component in order to generate the response. So, determining whether the response is correctly generated based on the indirect data determines whether the second component has the capability of determining the indirect data. When the response matches an expected response based on the indirect data, the second component is determined to be authentic. When the response does not match the expected response based on the indirect data, the second component is determined to be non-authentic.

In certain implementations, determining whether the second component is authentic comprises using the response and the indirect data to perform an authentication algorithm. For example, an operation may be performed using the indirect data and the result compared with the response to determine if the operation was successfully performed by the second component to generate the response. In this way, it can be determined if the second component correctly determined the indirect data from the communication sent to the second component by the first component.

There is further provided a replaceable component for an electronic device, the replaceable component configured to, when installed in the electronic device: receive data from a first component of the electronic device by: determining indirect data from a feature of a communication between the first component of the electronic device and the replaceable component, and/or send data to the first component of the electronic device by: converting indirect data into a feature of a communication and causing the communication to occur between the first component and the replaceable component. The replaceable component may be configured to perform one or more of the methods described above. In certain implementations, the communication is a data line communication.

In certain implementations, the replaceable component is further configured to perform an authentication algorithm based on the indirect data.

There is further provided an electronic device, the electronic device comprising a component configured to: receive data from a replaceable component installed in the electronic device by: determining indirect data from a feature of a communication between the component of the electronic device and the replaceable component, and/or send data to the replaceable component installed in the electronic device by: converting indirect data into a feature of a communication and causing the communication to occur between the component and the replaceable component. In certain implementations, the communication is a data line communication.

In certain implementations, the indirect data indicates functionality to be performed by the replaceable component and/or component. In certain implementations, the functionality to be performed is an algorithm and the electronic device stores a look-up table for setting a property of the algorithm based on the indirect data. In certain implementations, the indirect data is an index into direct data sent in the communication. In certain implementations, the indirect data is an input to a computation to be performed by the replaceable component and/or component on direct data sent in the communication.

In certain implementations, the indirect data is encoded in a property of the feature. In certain implementations, the property is a number of bytes in the feature. In certain implementations, the property is a number of transmissions in the feature. In certain implementations, the electronic device is further configured to determine whether the replaceable component installed in the electronic device is authentic, based on (i) indirect data received from the replaceable component, and/or (ii) a response received from the replaceable component to indirect data sent to the replaceable component. In certain implementations, determining whether the replaceable component is authentic comprises using the response and/or the indirect data to perform an authentication algorithm.

There is further provided an electronic system comprising the electronic device as described above and a replaceable component installed in the electronic device, the replaceable component configured to, when installed in the electronic device: receive data from a first component of the electronic device by: determining indirect data from a feature of a communication between the first component of the electronic device and the replaceable component, and/or send data to the first component of the electronic device by: converting indirect data into a feature of a communication and causing the communication to occur between the first component and the replaceable component. In certain implementations, the communication is a data line communication.

There is further provided an electronic system comprising an electronic device as described above and a replaceable component as described above.

In certain implementations of the above methods, electronic devices, replaceable components and electronic systems, when it is determined that a component or replaceable component is non-authentic, normal operation of the electronic device is prevented. In certain implementations, preventing normal operation of the electronic device comprises interrupting signals sent to a print component. A print component may be a print head, a monitor-enforce block or another component utilised in printing by the electronic device. Preventing the normal operation of the electronic device may be performed by host firmware or by the component, or by a third component such as a security device.

In this specification, components ‘of’ an imaging device may be removable parts, such as supply items, installed in the imaging device or may be inherent component parts of the imaging device. The term imaging system is used to describe a system comprising an imaging device and installed removable parts, such as one or more supply items.

In any of the implementations/embodiments described herein, the components may be connected via any communication protocol, such as a shared bus, such as I2C or peer-to-peer.

The methods, devices, supply items and systems described above may be employed in any combination. The optional features described above are equally applicable to all of the described methods, devices, supply items and systems and are not limited to the particular method/device/supply item/system with which they are described. The essential features of any of the methods, devices, supply items and systems described may be optional features of any other methods, devices, supply items and systems described.

From the foregoing disclosure and the following detailed description of various examples, it will be apparent to those skilled in the art that the present disclosure provides a significant advance in the art of determining the authenticity of a component an electronic system. Additional features and advantages of various examples will be better understood in view of the detailed description provided below.

As used herein, the term ‘leader’ is equivalent to the term ‘master’ and can be used interchangeably throughout without changing the meaning. As used herein, the term ‘follower’ is equivalent to the term ‘slave’ and can be used interchangeably throughout without changing the meaning. Both terms ‘master’ and ‘slave’ take their usual meanings in the art, for example, as used in the official I2C specification.

### BRIEF DESCRIPTION OF THE DRAWINGS

The above-mentioned and other features and advantages of the present disclosure, and the manner of attaining them, will become more apparent and will be better understood by reference to the following description of examples taken in conjunction with the accompanying drawings. Like reference numerals are used to indicate the same element throughout the specification.

FIG. 1 is a diagrammatic view of an imaging system.

FIG. 2 is a flow chart showing a first part of a method of communicating indirect data in a first component of an imaging system.

FIG. 3 is flow chart showing the method of communicating indirect data in a second component of the imaging system.

FIG. 4 is a flow chart showing a second part of a method of communicating indirect data in a first component of the imaging system.

FIG. 5 is a flow chart showing a method of communicating indirect data in a first component of an imaging system.

FIG. 6 is a flow chart showing a method of communicating indirect data in a second component of an imaging system.

### DETAILED DESCRIPTION OF THE DRAWINGS

It is to be understood that the disclosure is not limited to the details of construction and the arrangement of components set forth in the following description or illustrated in the drawings. The disclosure is capable of other examples and of being practiced or of being carried out in various ways. For example, other examples may incorporate structural, chronological, process, and other changes. Examples merely typify possible variations. Individual components and functions are optional unless explicitly required, and the sequence of operations may vary. Portions and features of some examples may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

It will be further understood that each block of the flow charts, and combinations of blocks in the flow charts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the flow charts discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the flow charts support combinations of means for performing the specified functions, combinations of steps for performing the specified functions and program instruction means for performing the specified functions. It will also be understood that each block of the flow charts, and combinations of blocks in the flow charts, can be implemented by special purpose hardware-based computer systems that perform the specified functions or steps or combinations of special purpose hardware and computer instructions.

Disclosed are example systems and methods for communicating data in an electronic system, such as an imaging/printer system.

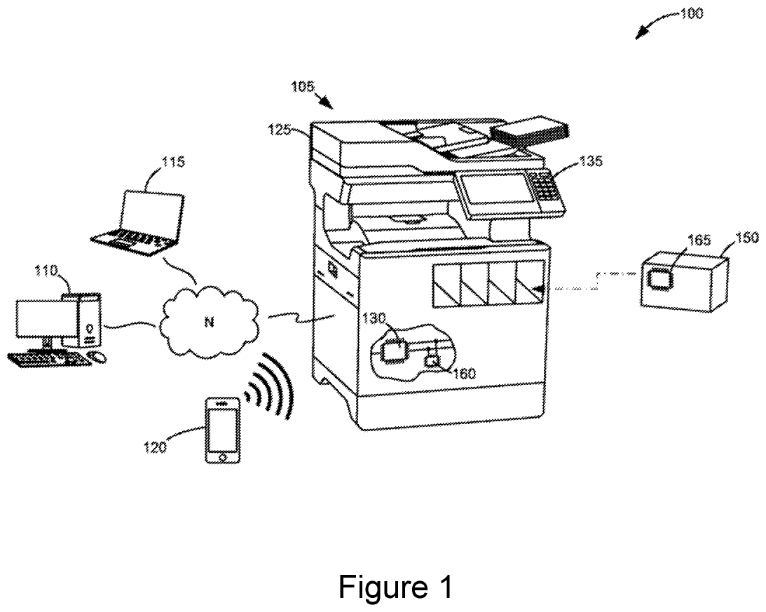

Referring to FIG. 1, there is shown a diagrammatic view of an imaging system 100 used in association with the present disclosure. Imaging system 100 includes an imaging device 105 used for printing images on sheets of media. Image data of the image to be printed on a media sheet may be supplied to imaging device 105 from a variety of sources such as a computer 110, laptop 115, mobile device 120, scanner 125 of the imaging device 105, or like computing device. The sources directly or indirectly communicate with imaging device 105 via wired and/or wireless connections.

Imaging device 105 includes an imaging device component 130 and a user interface 135. Imaging device component 130 may include a processor and associated memory. In some examples, imaging device component 130 may be formed as one or more Application Specific Integrated Circuits (ASICs) or System-on-Chip (SoCs). Memory may be any memory device which stores data and may be used with or capable of communicating with processor. For example, memory may be any volatile or non-volatile memory or combination thereof such as, for example, random access memory (RAM), read-only memory (ROM), flash memory and/or non-volatile RAM (NVRAM) for storing data. Optionally, imaging device component 130 may control the processing of print data. Optionally, imaging device component 130 may also control the operation of a print engine during printing of an image onto a sheet of media.

In one example, imaging device 105 may employ an electronic authentication scheme to authenticate consumable supply items and/or replaceable units installed in imaging device 105. In FIG. 1, a representative consumable supply item/replaceable item, such as a toner cartridge 150, is shown (other consumable/replaceable supply items can equally be used in addition or instead, such as imaging units and fusers). Supply item 150 may be installed in a corresponding storage area in imaging device 105. To perform authentication of supply item 150, imaging device 105 may utilize an imaging device security device 160 incorporated in imaging device 105 and a supply item security device 165 of supply item 150.

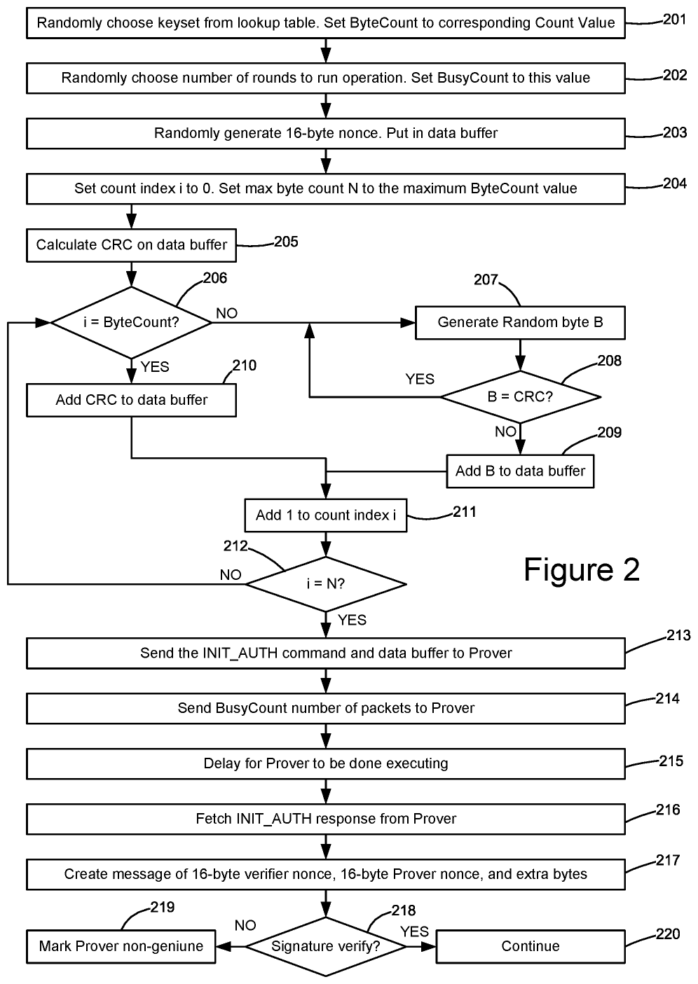

A first part of a method of communicating indirect data in a first component of an imaging system will now be described with reference to FIG. 2. In this method, the first component sends data to a second component installed in the imaging device by converting indirect data into a feature of a communication and causing the communication to occur between the first and second components.

The method communicates the number of rounds to run an operation via the number of busy responses sent and also communicates an index to the data of the communication via the number of bytes in a transmission of the communication. In this case, the number of bytes tells the second component how many bytes of the direct data to use in a signature operation.

At step 201, the first component of the imaging device, which may be referred to as a verifier, randomly chooses a keyset from a look-up table stored on the first component. The corresponding count value in the look-up table is set as the ByteCount value which determines the number of bytes in the feature to be communicated.

At step 202, a random number is chosen as the number of times to run an operation. The BusyCount is set to the chosen number. At step 203, a 16-byte nonce (a random or pseudo-random number) is generated and stored in a data buffer. It will be recognized that other sizes of data may be used as a start for the data buffer. Then, at step 204, a count index i is initialized at 0 and a count N is initialized at the maximum possible ByteCount value.

Steps 205 to 212 generate a CRC (Cyclic Redundancy Check) of data of the length of the ByteCount value and add it to the data buffer once the data buffer is ByteCount bytes long. The CRC signals to the receiver of the data that the end of number of bytes has been reached and allows the received to determine the ByteCount value and determine the indirect data. It will be recognized that other forms of check value may be utilized in other embodiments.

In more detail, at step 205, the CRC of the 16-byte data buffer is calculated. In some embodiments, the 16-byte buffer may be omitted, for example, the 16-byte buffer may be omitted from a second run of the method onwards. At step 206, it is checked if the bytes added are equal to the ByteCount value. When the bytes added are not equal to ByteCount, at step 207, a random byte is generated and added to the data buffer at step 209 as long as the generated byte is not coincidentally equal to the CRC of the data buffer so far as checked at step 208. If the generated byte was coincidentally equal to the CRC of the data buffer so far, the receiver would think that the end of the number of bytes had been reached prematurely, so this should be avoided in establishment of the feature to avoid errors occurring. If the generated byte is coincidentally equal to the CRC of the data buffer so far, then a new random byte is generated at step 207. The count i is increased by one at step 211 to track that one byte has been added to the data buffer and the method returns to step 205.

Once the count i reaches the ByteCount value, the CRC is added to the data buffer at step 210. The data added so far is considered the first portion of the feature of the communication and the CRC is the check value of the feature of the communication. Then, the addition of bytes continues using steps 211, 212 and 205 to 209 until the count i reaches the maximum possible Byte Count value N. The bytes included after the check value are considered to be the second portion of the feature of the communication. By continuing the process to reach the same overall size of data regardless of the ByteCount, the second component must calculate the CRC in order to determine the ByteCount value. This means that non-authentic components cannot work out the ByteCount value by simply measuring the overall size of the data sent.

At step 213 a communication including a command to start an authentication process and the established data buffer is sent to the second component, which may be referred to in this example as a prover. The data buffer is the feature of the communication that encodes the indirect data relating to the keyset. The property of the feature encoding the indirect data is the number of bytes in the first portion. At step 214, the first component sends BusyCount number of packets to the second component. These packets will arrive at the second component while the second component is busy reading and processing the data already sent.

At step 215, the first component then waits for the second component to finish executing the operations required and then at step 216, the response is fetched from the second component and received at the first component.

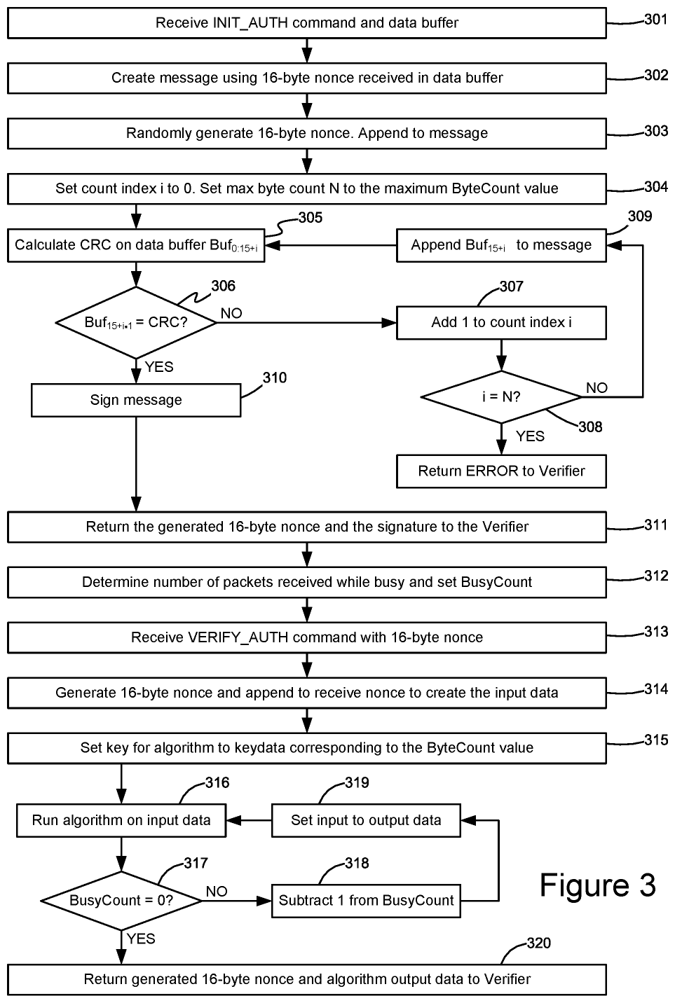

Turning to FIG. 3 which describes a method carried out by the second component, the second component receives the communication including the command to start the authentication process and the established data buffer at step 301. At step 302, a message is created using the 16-byte nonce from the data buffer received at step 302. At step 303, a new random 16-byte nonce is generated and appended to the message.

At step 304, a buffer count index i is initialized at 0 and a count N is initialized at the maximum possible ByteCount value.

Steps 305 to 310 work out the length of the first portion and apply a signature to the first portion. In more detail, at step 305, a CRC of bytes 0 to 15+i of the data buffer received from the first component is calculated. Then at step 306, it is checked if the next byte (15+i+1) is equal to the calculated CRC. If it is not, then at step 307, 1 is added to the count i and it is checked if i=N at step 308. If i=N, then an error is produced and sent to the first component because the count has reached the maximum ByteCount without finding a valid CRC. If i is not equal to N, then at step 309, the next byte of the data buffer is added to the message. Once the condition at step 306 is met, the message is signed and the 16-byte nonce generated at step 303 and the signature is sent to the first component.

At step 312, the second component determines how many packets were received while it was busy and sets this as the BusyCount.

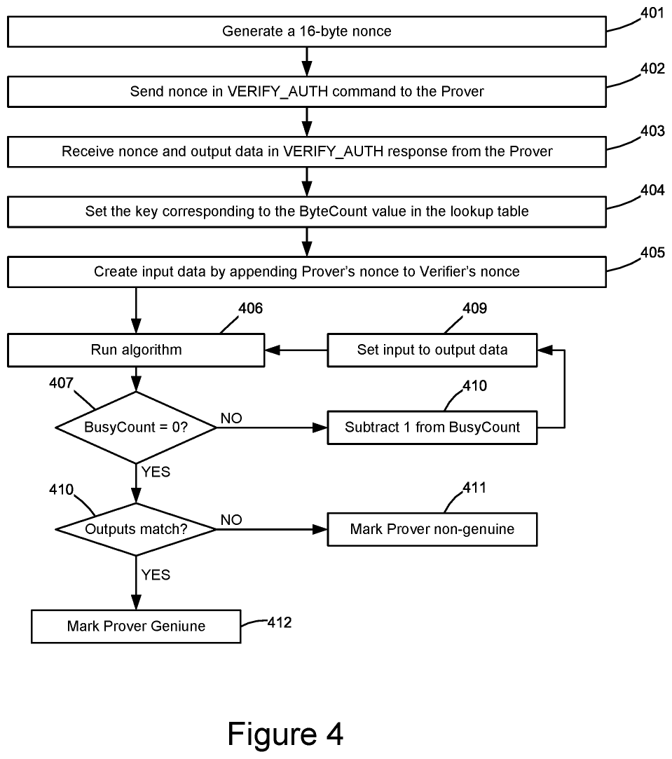

Turning back to FIG. 2 at the first component, at step 217, a message is created at the first component including the 16-byte nonce generated at step 203, the 16-byte nonce received from the second component and extra bytes added in step 207. At step 218 a signature operation is carried out on the message and if the signature is verified and if the signature is not verified, the second component is marked as non-authentic at step 219. Otherwise, the first component continues with the method of FIG. 4 as indicated by step 220.

When the signature is verified, the method carried out on the first component continues at FIG. 4 and step 401 in which the first component generates a third 16-byte nonce. At step 402, the new 16-byte nonce and a verification command are sent to the second component.

Turning back to FIG. 3, when the third 16-byte nonce and a verification command are received at the second component at step 313, a new fourth 16-byte nonce is generated and appended to the third 16-byte nonce to create input data at step 314. At step 315, the key for the algorithm is set as the key data corresponding to the ByteCount value determined via count i at step 307. The key data is retrieved from a look-up table stored on the second component. The indirect data communicated via the number of bytes in the first portion of the data buffer is used to determine functionality carried out here by setting a property of the algorithm carried out. In this case, the key to be used.

At step 316 an algorithm is run using the key data and the input data. Steps 317, 318 and 319 cause the algorithm to be run for the number of times indicated by the BusyCount which was set by the number of packets received while busy at step 312. Here a further feature of communication caused by the first component (the number of packets received while busy) has provided indirect data (the busy count) which has determined functionality (the number of times to perform the algorithm at step 316) performed by the second component. Packets may also be referred to as transmissions.

Once the algorithm has been performed for the BusyCount number of times, the fourth 16-byte nonce and the algorithm output data is returned to the first component.

Turning back to FIG. 4, the first component receives the fourth 16-byte nonce and the output data as a response to the verification command at step 403. The first component then runs the same process as the second component using steps 404 to 410. The key data is set using the look-up table stored at the first component at step 404, the input data is recreated by appending the fourth 16-byte nonce to the third 16-byte nonce at step 405 and the algorithm is run for the BusyCount number of times at steps 406, 407, 408 and 409. The output is checked against the received output at step 410 and if the outputs match, it is determined that the second component is authentic at step 412. If the outputs do not match, it is determined that the second component is non-authentic at step 411.

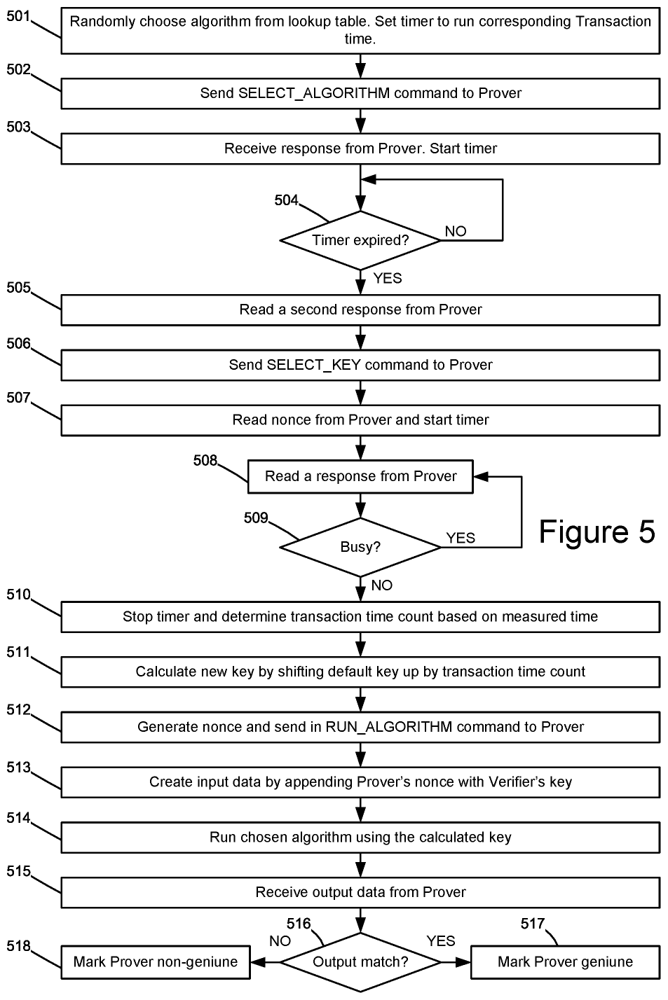

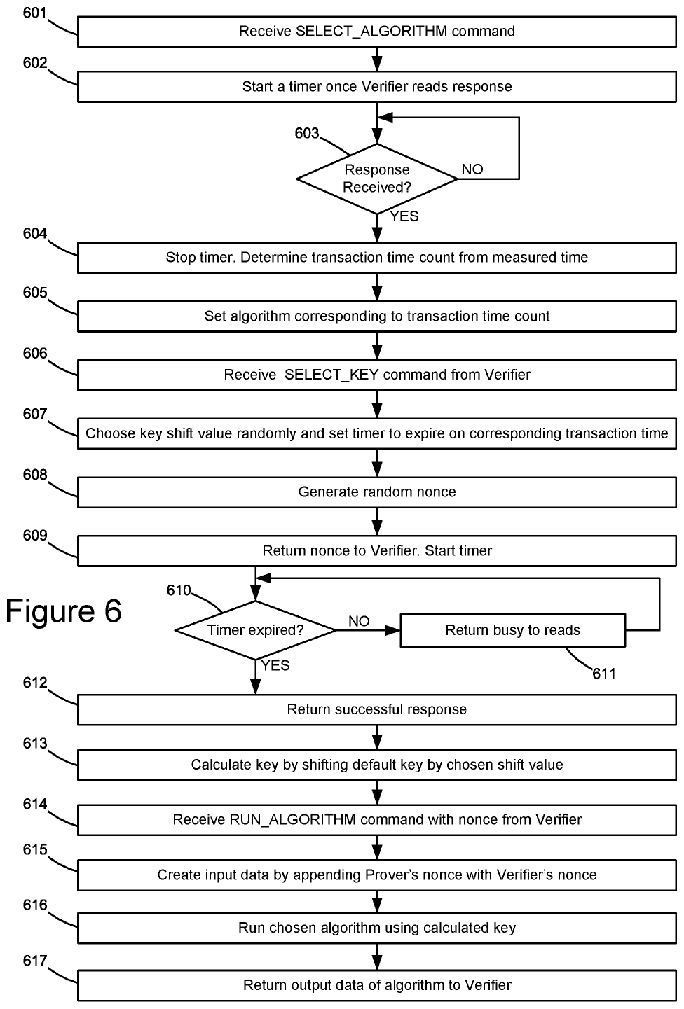

Another method of communicating data between a first component and a second component will be described with reference to FIGS. 5 and 6. FIG. 5 shows actions carried out by the first component and FIG. 6 shows actions carried out by the second component.

At step 501, the first component randomly chooses an algorithm from a look-up table stored on, or accessible by the first component. The look-up table matches algorithms with transaction times, otherwise known as time periods. The first component then sets a first timer to run for a first transaction time that corresponds to the selected algorithm. An example table is below:

| Transaction | | Set Transaction | Transaction | |
|---|---|---|---|---|
| Time Count | Algorithm | Time | Time Range | |
| 0 | AES | 5 ms | 0-10 | ms |
| 1 | 3DES | 15 ms | 10-20 | ms |
| 2 | SHA256 | 25 ms | 20 | ms+ |

At step 502, the first component sends a select algorithm command to the second component. Turning to FIG. 6, at step 601, the second component receives the select algorithm command from the first component. The select algorithm command causes the second component to send a response and to start a second timer when the response is read by the first component at step 602. At step 603, the second component continuously checks if a further response has been read by the first component. Once the response is received, at step 604, the second component stops the second timer and determines the first transaction time count based on the measured first transaction time. The transaction time count is found from the look-up table matching ranges of transaction time with count values. At step 605, the algorithm is set to the algorithm corresponding to the first transaction time count using a look-up table accessible by the second component.

At FIG. 5, step 503, when the response is received from the second component from step 602, the first component starts the first timer which has been set to the first transaction time corresponding to an algorithm via the look-up table. At step 504, the first component continuously checks if the timer has expired. Once the timer has expired indicating that the first transaction time has passed, the first component reads a second response from the second component at step 505. At step 506, a select key command is sent to the second component.

At step 606 of FIG. 6, the select key command is received by the second component. At step 607, the key shift value is selected at random from a look-up table accessible to the second component and the second timer is set to expire on the corresponding second transaction time. At step 608, a random first nonce is generated and returned to the first component at step 609 when the second timer is also started. At step 610, the second component continuously checks if the second timer is expired and if the timer is not expired, returns a busy response to read transmissions received at step 611. Once the timer is expired, indicating that the second transaction time has passed, a successful response is returned to the first component at step 612.

Meanwhile, at the first component, when the first nonce from the second component is received and read at step 507, the first timer is also started. At steps 508 and 509, the first component continuously reads responses from the second component. While the response is busy, the first component continues reading responses. Once the response is not busy, the first timer is stopped at step 510 and indicates the measurement of the second transaction time. A second transaction time count is determined based on the measured second transaction time using the look-up table. At step 511, a new key is calculated by shifting the current key up by the second transaction time count. Then, at step 512, a second nonce is generated and sent in a run algorithm command to the second component.

At step 513, input data is created by appending the first nonce to the second nonce and then, at step 514, the selected algorithm is run with the shifted key and the input data. The functionality of the first component is determined or changed by the indirect data sent to the second component via the first transaction time and by the indirect data received from the second component via the second transaction time.

Meanwhile, at step 613, the second component calculates the new key by shifting the current key up by the selected key shift value. At step 614, the second component receives a run algorithm command from the first component. The second component then generates the input data by appending the first nonce to the second nonce at step 615 and running the algorithm using the shifted key and the input data at step 616. The output data of the algorithm is returned to the first component at step 617.

When the first component receives the output data from the second component at step 515, the first component checks if the output data from the second component matches the output data from the algorithm run on the first component at step 516. If the outputs match, then the second component is determined to be an authentic component at step 517. If the outputs do not match, then the second component is determined to be a non-authentic component at step 518. Thus the indirect data sent and received by the first and second components is utilized to determine the authenticity of the second component.

In the above implementations/embodiments, the various components are configured as leader/follower components. This is purely optional and other communication busses may be used.

It will be understood that the example applications described herein are illustrative and should not be considered limiting. It will be appreciated that the actions described and shown in the example flow charts may be carried out or performed in any suitable order. It will also be appreciated that not all of the actions described in FIG. 2 to FIG. 6 need to be performed in accordance with the example embodiments of the disclosure and/or additional actions may be performed in accordance with other example embodiments of the disclosure.

Many modifications and other embodiments of the disclosure set forth herein will come to mind to one skilled in the art to which these disclosures pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Further disclosure is provided below.

Statement 1: A method of sending data by a first component of an imaging device, to a second component of the imaging device, the method comprising: converting, by the first component, indirect data into a feature of a communication and causing the communication to occur between the first and second components, wherein the communication is a data line communication.

Statement 2: The method of statement 1, wherein converting indirect data into the feature of the communication comprises establishing a property of the feature, based on the indirect data.

Statement 3: The method of statement 2, wherein the property is a number of bytes in the feature.

Statement 4: The method of statement 3, wherein the feature comprises: a first portion having the number of bytes, a check value of the first portion and a buffer portion.

Statement 5: The method of statement 2, wherein the property is a number of transmissions in the feature.

Statement 6: The method of statement 2, wherein the property is a time period of the feature.

Statement 7: The method of statement 6, wherein the feature comprises sending a first transmission, waiting for the time period and then sending a second transmission.

Statement 8: A method of determining authenticity of a second component installed in an imaging device, the method comprising: sending data from the first component of an imaging device to a second component of the imaging device according to the method of statement 1, receiving a response from the second component at the first component, and determining whether the second component is authentic based on the response.

Statement 9: The method of statement 8, wherein determining whether the second component is authentic comprises using the response and the indirect data to perform an authentication algorithm.

Statement 10: An imaging device, the imaging device comprising a component configured to: receive data from a supply item installed in the imaging device by: determining indirect data from a feature of a communication between the component of the imaging device and the supply item, wherein the communication is a data line communication, and/or send data to the supply item installed in the imaging device by: converting indirect data into a feature of a communication and causing the communication to occur between the component and the supply item, wherein the communication is a data line communication.

Statement 11: The imaging device of statement 10, wherein the indirect data indicates functionality to be performed by the supply item and/or component.

Statement 12: The imaging device of statement 11, wherein the functionality to be performed is an algorithm and the imaging device stores a look-up table for setting a property of the algorithm based on the indirect data.

Statement 13: The imaging device of statement 11, wherein the indirect data is an index into direct data sent in the communication.

Statement 14: The imaging device of statement 11, wherein the indirect data is an input to a computation to be performed by the supply item and/or component on direct data sent in the communication.

Statement 15. The imaging device of statement 10, wherein the indirect data is encoded in a property of the feature.

Statement 16: The imaging device of statement 15, wherein the property is a number of bytes in the feature.

Statement 17: The imaging device of statement 15, wherein the property is a number of transmissions in the feature.

Statement 18: The imaging device of statement 10, the imaging device further configured to determine whether the supply item installed in the imaging device is authentic, based on (i) indirect data received from the supply item, and/or (ii) a response received from the supply item to indirect data sent to the supply item.

Statement 19: The imaging device of statement 18, wherein determining whether the supply item is authentic comprises using the response and/or the indirect data to perform an authentication algorithm.

Statement 20: An imaging system comprising the imaging device of statement 10 and a supply item installed in the imaging device, the supply item configured to, when installed in the imaging device: receive data from a first component of the imaging device by: determining indirect data from a feature of a communication between the first component of the imaging device and the supply item, wherein the communication is a data line communication, and/or send data to the first component of the imaging device by: converting indirect data into a feature of a communication and causing the communication to occur between the first component and the supply item, wherein the communication is a data line communication.

1. A method of receiving data from a first component of an imaging device, by a second component of the imaging device, the method comprising:
determining, by the second component, indirect data from a feature of a communication between the first and second components of the imaging device, wherein the communication is a data line communication.

2. The method of claim 1, wherein determining indirect data from the feature of the communication comprises measuring a property of the feature.

3. The method of claim 2, wherein measuring the property of the feature comprises counting.

4. The method of claim 3, wherein the property is a number of bytes in the feature.

5. The method of claim 3, wherein the property is a number of transmissions.

6. The method of claim 5, wherein the number of transmissions is a number of a type of transmission.

7. The method of claim 6, wherein the type of transmission is a busy response.

8. The method of claim 5, wherein the number of transmissions is a number of consecutive transmissions of the same type.

9. The method of claim 2, wherein measuring the property of the feature comprises timing.

10. The method of claim 9, wherein the property is a time period between receiving two transmissions and timing comprises measuring the length of the time period.

11. The method of claim 9, wherein the property is a time period over which a type of transmission is received and timing comprises measuring the length of the time period.

12. The method of claim 1, wherein receiving data further comprises using the indirect data to determine functionality to be performed by the second component.

13. The method of claim 12, wherein the functionality to be performed by the second component is an algorithm and the method further comprises determining a property of the algorithm via a look-up table.

14. The method of claim 12, wherein using the indirect data to determine functionality to be performed by the second component comprises using the indirect data as an index into direct data sent in the communication.

15. The method of claim 12, wherein using the indirect data to determine functionality to be performed by the second component comprises using the indirect data as an input to a computation on direct data sent in the communication.

16. A method of communicating data between a first and a second component of an imaging device comprising:
sending the data by the first component of the imaging device, to the second component of the imaging device by converting, by the first component, the data into a feature of a communication and causing the communication to occur between the first and second components, wherein the communication is a data line communication, and
receiving the data from the first component of the imaging device, by the second component of the imaging device according to the method of claim 1.

17. A supply item for an imaging device, the supply item configured to, when installed in the imaging device:
receive data from a first component of the imaging device by:
determining indirect data from a feature of a communication between the first component of the imaging device and the supply item, wherein the communication is a data line communication, and/or
send data to the first component of the imaging device by:
converting indirect data into a feature of a communication and causing the communication to occur between the first component and the supply item, wherein the communication is a data line communication.

18. The supply item of claim 17, wherein the supply item is further configured to perform an authentication algorithm based on the indirect data.

19. A method of determining authenticity of a first component installed in an imaging device, the method comprising:
receiving data from the first component of an imaging device, by a second component of the imaging device according to the method of claim 1,
determining whether the first component is authentic based on the received data.

20. The method of claim 19, wherein determining whether the first component is authentic comprises using the indirect data to perform an authentication algorithm.
